(19) United States
(12) Patent Application Publication
(10) Pub. No.: US 2004/0217733 A1
(43) Pub. Date: Nov. 4, 2004

(54) Mobile device with charging circuit for charging the same

(75) Inventors: Fang-Bin Liu, Hsinchu (TW); Meng-Ju Lin, TaiChung (TW); Chih-Hsin Lee, ChinMen Hsien (TW)

Correspondence Address: BRUCE H. TROXELL, SUITE 1404, 5205 LEESBURG PIKE, FALLS CHURCH, VA, 22041, US

(73) Assignee: BENQ Corporation

(21) Appl. No.: 10/829,943

(22) Filed: Apr. 23, 2004

(30) Foreign Application Priority Data
Apr. 29, 2003 (TW) 92206761

(51) Int. Cl. H02J 7/00

(52) U.S. Cl. 320/114

(57) ABSTRACT

The present invention is related to a mobile device having a built-in charging circuit that is able to charge another mobile device by providing a charging voltage to that mobile device via an external voltage regulation module connecting to that mobile device. The charging circuit comprises: a charging/discharging terminal for connecting to a connecting port of another mobile device to proceed with an operation of charging/discharging; a protection circuit for protecting the charging circuit from damage by power overload; a current detection circuit for detecting the current value flowing in the charging circuit; a current direction control circuit for regulating the current flowing in the circuit according to the current value detected by the current detection circuit so as to restrict the current flowing in the circuit to be within the range of an ordinate operating current value; a battery.

### FIELD OF THE INVENTION

The present invention is related to a mobile device having a built-in charging circuit, more specifically, to a handheld mobile device that can employ another mobile device as a temporary power supply to enable a continuing usage of the out-of-power handheld mobile device.

### BACKGROUND OF THE INVENTION

Nowadays telecommunication life style is becoming more and more common for people all over the world by which most works can be accomplished by a few simple operation procedures. Consequently, a lot of errands can be done without even leaving home, but just by using one's handheld communication apparatus or computer. Thus, the working efficiency of people these days is several times better compared to that of their predecessor. In the aspect of wireless communication, since the cellular phone using the GSM system has advantages of easy to carry, stronger signal (almost no blind spot within a city's limit), and global roaming, etc., it has become a must-have electronic product for modem people. Moreover, since the operating time is restricted by the capacity of its battery and calling time, most users will buy a back-up battery in order to ensure having enough operating time while leaving home. But there are still times for a user to run out of his cellular phone's power and, and the same time, forget to bring the back-up battery along, therefore, an awkward condition of not able to use his cellular phone could happen. Although the problem can be solved temporary by changing the SIM card to another cellular phone, but those important personal information stored in the original cellular phone (such as personal phone book, schedules, reminders) are still inaccessible. In view of that, the object of the present invention is to enable a continuing usage of the original cellular phone during emergency by providing the original cellular phone with a temporary power supply.

### SUMMARY OF THE INVENTION

In view of the above drawback of the prior art, the primary object of the present invention is to provide a handheld mobile device (including cellular phone, PDA, and notebook computer, etc.) with a two-way charging circuit that is able to temporarily recover from an awkward condition of running out of power during emergency by connecting to another mobile device (which is not necessary to be of the same manufacture, and even can be of different kind of handheld mobile device, such as: PDA, digital camera, etc.) via a transmission line to proceed with a power transmission procedure.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a block diagram showing the function elements of a built-in charging system of cellular phone according to the present invention.

FIG. 2 is a 3-D schematic view showing a voltage regulation module connected externally to the connecting port of a cellular phone according to the present invention.

FIG. 3 is the circuitry of the voltage regulation module of FIG. 2.

FIG. 4 is a diagram depicting the circuitry of the charging/discharging system of a mobile phone according to the present invention.

### DESCRIPTION OF THE PREFERRED EMBODIMENT

For your esteemed members of reviewing committee to further understand and recognize the objectives, the characteristics, and the functions of the invention, a detailed description in matching with corresponding drawings are presented as the following.

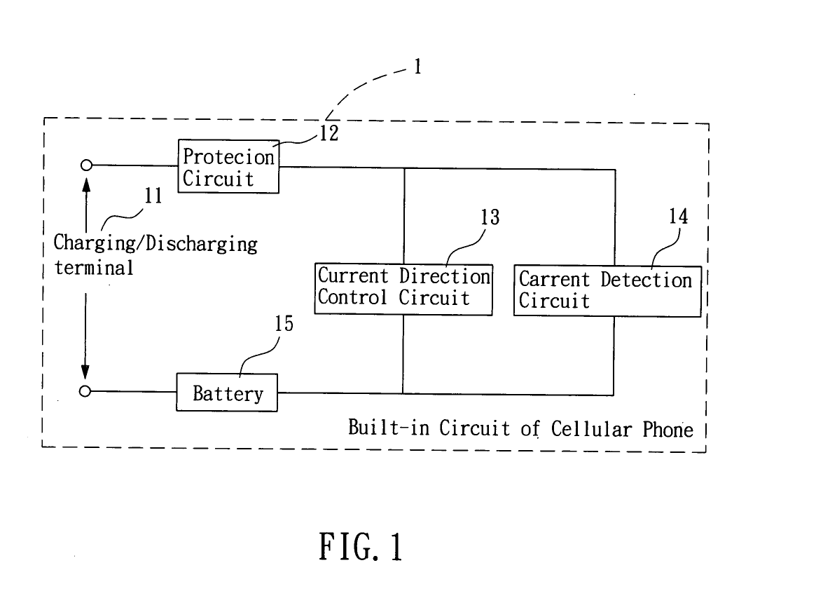

Please refer to FIG. 1, which is a block diagram showing the function elements of a built-in charging/discharging system of a cellular phone according to the present invention, wherein the charging/discharging system is accomplished by using the charging terminal of a cellular as a charging/discharging terminal 11, and the charging circuit thereof further comprises: a protection circuit 12, a current direction control circuit 13, a current detection circuit 14 and a battery 15. Moreover, the system comprises: a charging/discharging terminal 11 which is connected to the connecting port of the mobile device to proceed with an operation of charging/discharging, that is, when the connecting port is connected to a charger, the connecting port will receive a power transmitted from the charger to charge the mobile device; a protection circuit 12 that can protect the charging circuit and the battery from damage by power overload; a current detection circuit 14 that can detect the current value flowing in the charging circuit; a current direction control circuit 13 that can regulate the current flowing in the circuit according to the current value detected by the current detection circuit 14 so as to restrict the current flowing in the circuit to be in the range of an ordinate operating current value and without overloading an external battery which is charging the mobile phone, yet another function of the current direction control circuit is to redirect the direction of the current while charging/discharging; and a battery 15 installed inside the mobile device.

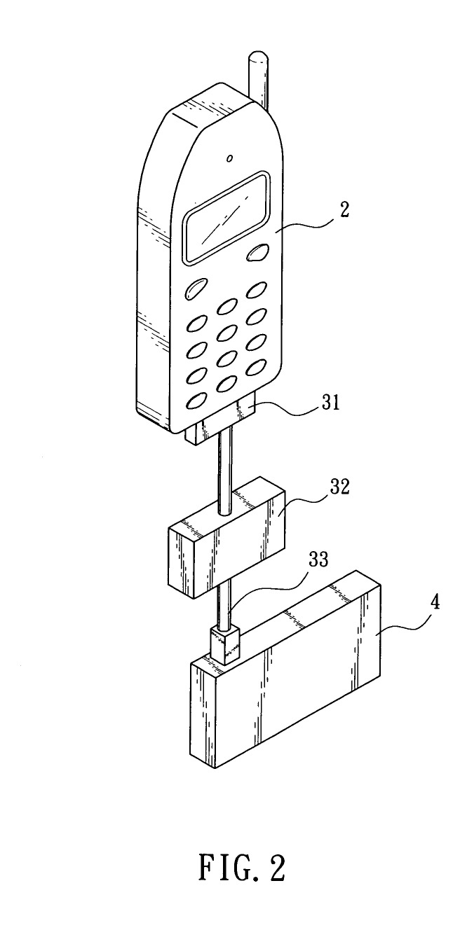

Please refer to FIG. 2, which is a 3-D schematic view showing a voltage regulation module connected externally to the connecting port of a cellular phone according to the present invention, wherein a first connecting port 31 of the first mobile device 2 is connected to a voltage regulation module 32, and then is connected to the second mobile device 4 via a second connecting port 33. The first mobile device 2 and the second mobile device 4 of the present embodiment should be not considered as limited and can be any handheld mobile device having at least one rechargeable battery, such as cellular phone, PDA, digital camera, etc. In the present embodiment, the charging/discharging system of FIG. 1 is required in the second mobile device 4. The first connecting port 31 of the first mobile device 2 inter-connects with the charging/discharging terminal of the charging/discharging circuit thereof (that is, charging/discharging operation is applied using the same charging/discharging port). The output voltage of the second mobile device 4 proceeding with an discharging operation must be rose to at least 4.2V (4.2V is the minimum voltage required to fully charge a Li-Ion Battery) and is conform with a charging curve, so that the charging current can be maintained in a stable state and thus the charging procedure can be accomplished without obstruction. At the same time that the first connecting port is set to be a charging terminal and the second connecting port is set to be a discharging terminal. When in the opposite condition, the charging/discharging system of FIG. 1 is required in the first mobile device 2, and the first connecting port and the second connecting port are simply reverse connected to the first mobile device 2 and the second mobile device 4. Moreover, the voltage regulation module 32 is different according to the different mobile device used, and the first connecting port and the second connecting port are also having different design according the different mobile device used.

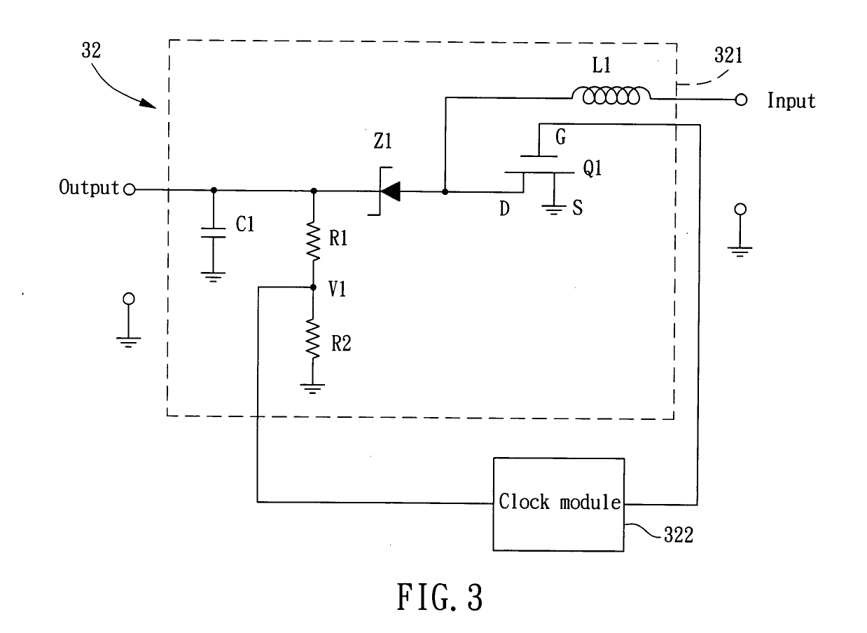

Please refer to FIG. 3 for a detail description of the circuitry of the voltage regulation module 32. As seen in FIG. 3, the voltage regulation module 32 comprises an energy-storage circuit 321 and a clock module 322, wherein the energy-storage circuit 321 sends a feedback voltage to the clock module 322 by which the clock module 322 will generate a period corresponding to the voltage V1, such that the energy-storage circuit 321 adjusts the output voltage thereof according to the input period. The energy-storage circuit comprises: an energy-storage unit L1, and C1; a voltage suppressor diode Z1 and voltage divider circuit R1, R2; and a switch Q1. The inputted clock enables the switch Q1 to function accordingly. During a long period, the energy storage unit will store more electric energy such that the output voltage is increased, that is, the voltage V1 is increased. Thus, if V1 is smaller than a predetermined voltage, the clock module 322 will generate a clock with longer period, and if V1 is larger than a predetermined voltage, the clock module 322 will generate a clock with shorter period, by which the output voltage can be adjusted to achieve the intended voltage range.

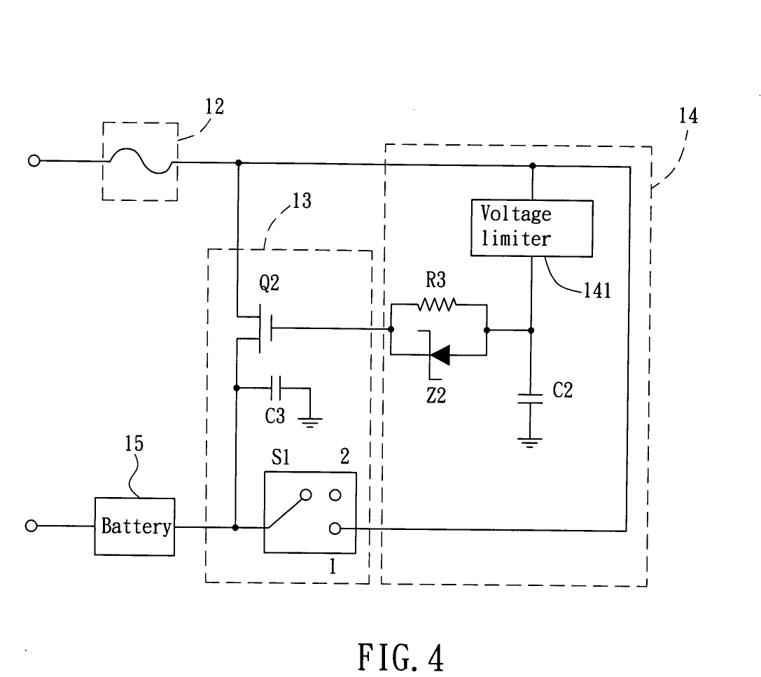

FIG. 4 is a diagram depicting the circuitry of the charging/discharging system of a mobile phone according to the present invention. The protection circuit 12 seen in FIG. 4 is a safety fuse for protecting the circuit from excess current. The current direction control circuit 13 comprises a switch S1 and a control unit Q2. While discharging from the battery 15 to charge an external device, the switch S1 is connected to the terminal 1 for the current to flow out, and while charging the battery 15, the switch S1 is connected to the terminal 2 for the current to flow in. While charge the battery 15 using an external power supply, a protection mechanism is required for protecting the current detection circuit 14 since the external voltage and current may be instable. As soon as the charging current exceeds an allowable value, the protection mechanism will stop the charging process even when the control unit Q2 is on. The current detection circuit includes a voltage limiter 141, a resistor R3, a diode Z2 and a capacitor C2. When the input voltage is higher than the voltage defined by the voltage limiter 141, the voltage limiter 141 will enable the capacitor C2 to discharge and the control unit Q2 to become open circuit, that is, no more current can flow across the terminal 2 such that the battery 15 alone with the internal circuit of the mobile phone are protected.

As shown in FIG. 1 to FIG. 4, the present invention can provide a handheld mobile device (including cellular phone, PDA, and notebook computer, etc.) with a two-way charging circuit that is able to temporarily recover from an awkward condition of running out of power during emergency by connecting to a second mobile device (not necessary to be of the same manufacture, and even can be of different kind of handheld mobile device, such as: PDA, digital camera, etc.) via a transmission line to proceed with a power transmission procedure.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A mobile device having a built-in charging circuit, said charging circuit being coupled to a voltage regulation module to transform a first voltage outputted from said charging circuit to a second voltage, and said voltage regulation module being further connected to an apparatus waiting to be charged for charging the apparatus by said second voltage, said charging circuit comprising:
a battery for providing power to said mobile device;
a current detection circuit for detecting a current value of said battery; and
a current direction control circuit, being used for regulating amount of current flowing in said voltage regulation circuit according to said current value so as to restrict current value of said battery to be within a predetermined range.

2. The mobile device of claim 1, wherein said charging circuit further comprises: a charging/discharging terminal, being selectively connected to a power supply for charging said mobile device and said voltage regulation circuit for charging said apparatus.

3. The mobile device of claim 2, wherein said charging/discharging terminal further comprises a first end and a second end, and said second end is connected to one end of said battery, and the other end of said battery is coupled to said current direction control circuit and said current detection circuit, and said first end is coupled to both another ends of said current direction control circuit and said current detection circuit.

4. The mobile device of claim 1, wherein said charging circuit further comprises: a protection circuit, being activated while said current of said battery exceed a safety limit to prevent said battery from damaged by power overload.

5. The mobile device of claim 1, wherein said second voltage is larger than said first voltage.

6. The mobile device of claim 1, wherein said second voltage is equal to 4.2V.

7. The mobile device of claim 1, wherein said mobile device is a cellular phone.

8. The mobile device of claim 1, wherein said mobile device is a PDA.

9. The mobile device of claim 1, wherein said mobile device is a digital camera.

10. The mobile device of claim 1, wherein said apparatus waiting to be charged is a cellular phone.

11. The mobile device of claim 1, wherein said apparatus waiting to be charged is a PDA.

12. The mobile device of claim 1, wherein said apparatus waiting to be charged is a digital camera.

13. A mobile device having a built-in charging circuit, comprising:
a voltage regulation module for receiving a first voltage, transforming the first voltage into a second voltage and outputting said second voltage to an apparatus waiting to be charged;
a charging circuit, further comprising:
a battery supplying power to said mobile device;
a charging/discharging terminal, being selectively connected a power supply for charging said mobile device and said voltage regulation circuit for charging said apparatus waiting to be charged;
a current detection circuit for detecting a current value of said battery; and
a current direction control circuit, being used for regulating amount of current flowing in said voltage regulation module according to said current value so as to restrict current of said battery to be within a predefined range.

14. The mobile device of claim 13, wherein said charging/discharging terminal further comprises a first end and a second end, and said second end is connected to one end of said battery, and the other end of said battery is coupled to said current direction control circuit and said current detection circuit, and said first end is coupled to both another ends of said current direction control circuit and said current detection circuit.

15. The mobile device of claim 13, wherein said charging circuit further comprises: a protection circuit, being activated while said current of said battery exceed a safety limit to prevent said battery from damaged by power overload.

16. The mobile device of claim 13, wherein said second voltage is larger than said first voltage.

17. The mobile device of claim 13, wherein said second voltage is equal to 4.2V.
